(19) United States
(12) Patent Application Publication
(10) Pub. No.: US 2005/0242544 A1
(43) Pub. Date: Nov. 3, 2005

(54) Indirect traction device for wheelchairs

(76) Inventor: Gonzalo Acosta Haab, Capital Federal (AR)

Correspondence Address: LADAS & PARRY, 26 WEST 61ST STREET, NEW YORK, NY, 10023, US

(21) Appl. No.: 11/088,237

(22) Filed: Mar. 23, 2005

(30) Foreign Application Priority Data
Mar. 31, 2004 (AR) P040101068

(51) Int. Cl. B62M 1/14

(52) U.S. Cl. 280/250.1

(57) ABSTRACT

A wheelchair has an indirect traction device and, optionally, caterpillars.

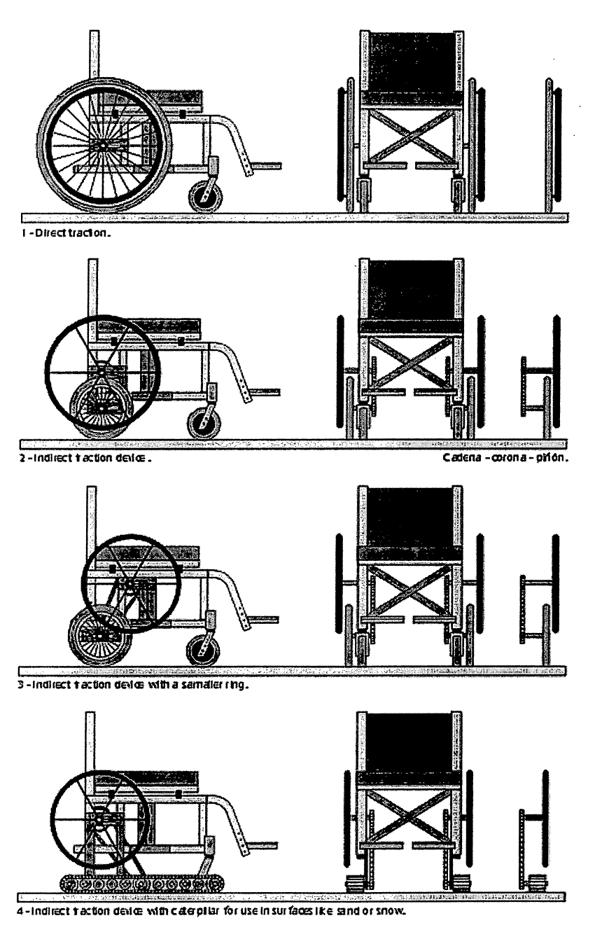

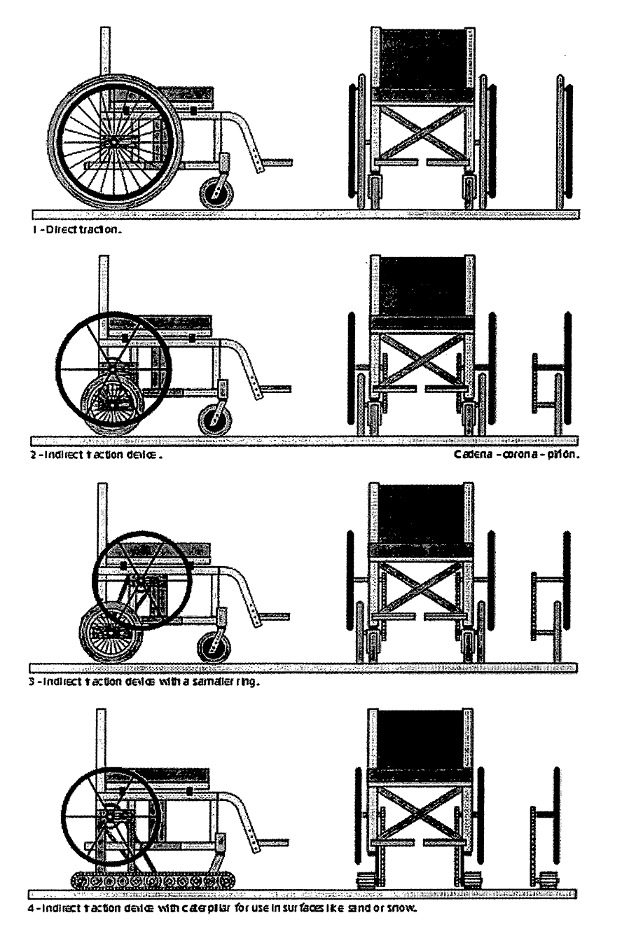

### BACKGROUND OF THE INVENTION

The present invention refers to the substitution of the current traction form for wheelchairs. This change consists in going from the direct traction to that of indirect traction, through a device that separates the propelling wheel rim from the supportive rear wheel, connecting them by means of a chain-crown-pinion system, such as the one used in bicycles.

Nowadays, wheelchairs propelled by users work all in the same way. The rear wheels have attached an external rim of a smaller diameter which allows the person sitting on the chair to propel. This direct traction presents problems such as:
Constant contact of the hands, forearms and clothing with the wheels; bringing up important hygiene problems, as many people sitting on the chair urinate with forms that requires complete cleanness. The lack of cleansing constantly causes urinary infections. The moment the user gets into the toilet room he does it touching the wheels with his hands, which in a way, is like saying he is touching the floor with his own hands.
The size of the wheels not only makes it difficult to get into the toilet, elevators and different means of transport but also getting onto the beds, vehicle seats and toilets.
The wheel makes the chair hard to carry in small or medium vehicles, and sometimes it does not fit in because of its size.
The maximum width of the chair depends on the rims, causing trouble when moving along corridors, through doorway archs and narrow door frames, etc.

### SUMMARY OF THE INVENTION

Avoid constant contact of hands to the wheels, with clear hygiene benefits for the overall condition of the disabled person.

Allow the rims to be removed whenever it is necessary, keeping the chair standing on its wheels.

The rim is released to be changed both in size or place, depending on the user's needs.

Modifying the connection pinion-crown and introducing gears, in order to achieve an outstanding ride, despite of the inconveniences in the conditions of the ground.

This new system can be adapted to every existing wheelchair.

Wheels can be replaced by caterpillars, making it possible to move along all types of soft grounds, such as sand or snow; something that was, up to now, not possible for a wheelchair user.

The purpose pursued by this invention is to improve the life quality of those who partially or totally depend on a wheelchair.

As the measures of the chair, both in length and width, will be reduced at a large extent, this will enable an easy transportation of it and facilitate the entrance to different places.

Those who use wheelchairs will find it easier to move along wet areas, dirty areas or surfaces with other obstacles, not having to bear in mind issues such as their own health nor hands and clothing hygiene.

Going up or down slopes won't be an impediment, it will be as easier as on a bicycle, considering the fact that a set of gears will be placed in the wheelchair. Thanks to the placing of the gears, the physically disabled people are going to find it easier to move forward becoming self-sufficient.

### BRIEF DESCRIPTION OF THE DRAWING

In order to clarify this new method of Indirect Traction for wheelchairs, I therefore present 4 diagrams:
Picture 1—it shows the Direct Traction in a regular wheelchair. In Picture 2, it is showed the Indirect Traction Device, placed on the same wheelchair of Picture 1.
Picture 2—are listed the following: 1. Propelling rim; 2. Rear wheel; 3. Chain-Crown-Pinion system; 4. Propelling rim axle; 5. Rear wheel axle.
Picture 3—it shows the Indirect Traction Device with a smaller rim, moved from its original place, which makes a difference from the previous pictures.

Picture 4—it shows the Indirect Traction Device with the rear wheels replaced by caterpillars.

### DETAILED DESCRIPTION OF THE INVENTION

This invention introduces and places an Indirect Traction Device in the wheelchairs. This new device consists of a pair of wheels which receive an impulse from the chain-crown-pinion system and joins them to the propelling rims.

The following parts are shown in Picture 2: 1. Propelling rim, 2. Rear wheel, 3. Chain-crown-pinion system, 4. Propelling rim axle and 5. Rear wheel axle.

The importance of this change can be compared to that of bicycles; which consisted in replacing the great big front wheel with pedals placed in its centre by a pair of smaller wheels with pedals that transmit the energy from the cyclist through the chain-crown-pinion system.

The current form of Direct Traction presents problems such as:
Constant contact of the hands, forearms and clothing with the wheels; bringing up important hygiene problems as many people sitting on the chair urinate with problems that requires complete cleanness. The lack of cleansing constantly causes urinary infections. The moment the user gets into the toilet room he does it touching the wheels with his hands, which in a way, is like saying he is touching the floor with his own hands.
The size of the wheels not only makes it difficult to get into the toilet, elevators and different means of transport but also getting onto the beds, vehicle seats and toilets.
The wheel makes the chair hard to carry in small or medium vehicles, and sometimes it does not fit in because of its size.
The maximum width of the chair depends on the rims, causing trouble when moving along corridors, through doorway archs and narrow door frames, etc.

The suggested form of Indirect Traction will allow the following solutions:
Avoid constant contact of hands to the wheels, with clear hygiene benefits for the overall condition of the disabled person.
Allow the rims to be removed whenever it is necessary, keeping the chair standing on its wheels and allowing the user to go through narrow places.
The rim is released to be changed both in size or place, depending on the user's needs and physical abilities.
Modifying the connection pinion-crown and introducing gears, in order to achieve an outstanding ride, despite of the inconveniences in the conditions of the ground. Moreover, allowing the user to handle the wheelchair in an easier way when being indoors.
This new system can be adapted to every existing wheelchair.
Wheels can be replaced by caterpillars, making it possible to move along all types of soft grounds, such as sand or snow; something that was, up to now, not possible for a wheelchair user.

1. (canceled)

2. The use of Indirect Traction Devices for those wheelchairs that make use of any other system to connect the propelling rims to the wheels, such as pulleys and driving beltas.

3. The wheelchairs manufactured with the Indirect Traction Device incorporated.

4. The wheelchairs manufactured with the Indirect Traction Device and caterpillars included.
